(19) United States
(12) Patent Application Publication
(10) Pub. No.: US 2015/0048703 A1
(43) Pub. Date: Feb. 19, 2015

(54) System for Generating and Recovering Energy

(71) Applicants: Gustavo Adolfo Maldonado, Puerto Vallarta (MX); Manuel Padilla, Puerto Vallarta (MX)

(72) Inventors: Gustavo Adolfo Maldonado, Puerto Vallarta (MX); Manuel Padilla, Puerto Vallarta (MX)

(21) Appl. No.: 14/459,431

(22) Filed: Aug. 14, 2014

Related U.S. Application Data
(60) Provisional application No. 61/865,720, filed on Aug. 14, 2013.

(51) Int. Cl. H02K 47/00; G06Q 50/06

(52) U.S. Cl. CPC H02K 47/00; G06Q 50/06; Y10S 74/09; H02K 53/00
USPC 310/113; 74/DIG. 9

(57) ABSTRACT

A system for generating and recovering energy comprising an electric generator integrated with a consumer's utility provider's network to generate electrical energy. Electrical power is transmitted from an electric power grid to a control box at a location requiring energy (e.g., home or business) via a bidirectional meter which measures power delivered by and to the power grid. The control box powers an AC driver which feeds a load to and controls the speed of a motor. A torque multiplier multiplies a first torque output from the motor to produce a second torque output which is fed to an alternator. The power generated by the electric generator is transmitted to a remote location for consumption. In one embodiment, exported energy is returned to the utility provider in exchange for credit against the consumer's account or for payment. In an alternative embodiment, the present invention functions as an independent power plant.

### CROSS REFERENCE TO RELATED APPLICATIONS

This original non-provisional application claims priority to and the benefit of U.S. provisional application Ser. No. 61/865,720, filed Aug. 14, 2013, and entitled “Freenergy GM Generator,” which is incorporated by reference herein.

### STATEMENT REGARDING FEDERALLY SPONSORED RESEARCH OR DEVELOPMENT

None.

### BACKGROUND OF THE INVENTION

1. Field of the Invention

The present invention relates to an alternative energy cogeneration system. More specifically, the present invention relates to an electric generator for generating sufficient power to sustain the energy requirements of the consumer, either residential or commercial, and exporting surplus power generated to a utility provider.

2. Description of the Related Art

Generally, when a consumer—whether residential or commercial—consumes energy, the energy comes from the electric company (i.e., the utility provider) via an electric power grid. The electricity passes through an electricity meter and into a main power switch box at a residence or commercial business to provide the energy needed to sufficiently meet the consumer's daily energy usage demands. Prices for obtaining energy vary depending on the season. For example, in the summer, temperatures can reach triple digits in some regions of the country requiring an increase in energy consumption to maintain the environment in a comfortable setting. Similarly, during the winter, additional energy is required to heat up the setting to a comfortable atmosphere. In regions where the climate is particularly harsh (e.g., inordinately high or low sustained temperatures), the utility bills can become difficult to manage and pay. The consumer can reduce their consumption costs by doing without certain high energy consuming appliances, e.g., heating, ventilation and air conditioning (HVAC) system, and other devices. However, this effectively makes it inconvenient and potentially dangerous for the consumer.

When power from the electric power grid fails (e.g., blackout, brownout, natural catastrophes, etc. . . . ), many people turn to generators to provide electricity to their home or business. There exist in the art generators that run on fossil fuel, e.g., gasoline, natural gas, diesel, bio-diesel, etc. . . . . These types of generators are often expensive, cumbersome, and noisy. These also contribute to an already polluted atmosphere and to climate change by releasing pollutants and carcinogens as byproducts.

Therefore, there is a need for a relatively compact, pollution-free, environmentally friendly, electric generator that can be integrated with a consumer's electricity supply network (i.e., electric power grid) and can supply the sufficient power requirements of an end user while simultaneously lowering the consumer's metered usage by generating a surplus of power and returning same to the utility provider for credit or payment.

### BRIEF SUMMARY OF THE INVENTION

The present invention is an electric energy recovery appliance, or electric generator. The present invention has application in both urban and rural settings. In an urban setting, the present invention is coupled to the electricity provider's network, i.e., electric power grid. Electric energy travels through the transmission lines of the electricity provider. The generator of the present invention generates the same amount of energy used during the day as was supplied by the utility provider. The energy generated by the generator in excess of what is required to meet the consumer's energy consumption demands is “returned” back to the utility provider generating a net zero account on the utility bill of (or even payment to) the consumer.

A bidirectional meter facilitates this process. After a series of step downs to bring the voltage to safe and manageable levels for consumer usage, the power arrives at the bidirectional meter of the home or business. The bidirectional meter, generally calibrated in kilowatt hour (kWh), is used to measure the amount of power used from the power grid when the electricity travels from the power grid to the consumer's residence or business. As the electricity passes through the bidirectional meter (and a reading is taken—for billing purposes), the electricity enters the home or business at the main power switch box. From the main power switch box, the electrical power travels to the electric generator's coupling module (i.e., control box) where the energy generated by the generator and the provider's energy couple together. This coupled energy then enters the circuit breaker load center which supplies all the user's energy demands.

Once the consumer's energy demands are met, the excess energy generated by the generator is exported back to the power grid. The bidirectional meter is also used to measure the amount of excess power generated by the present invention and exported to the power grid of the utility provider. When the amount of energy generated by the present invention and exported to the power grid is less than the amount of power delivered to the consumer from the power grid, a net credit towards the consumer's consumption bill is realized providing savings to the user of from 50-99%. In regions that allow for the purchase of energy by the utility provider, payment by the utility provider to the consumer may be made for the purchase of power generated when the amount of energy generated by the present invention and exported to the power grid is greater than the amount of power delivered to the consumer from the power grid. When the amount of electricity delivered equals the amount of electricity returned, the result is a net zero balance.

In one embodiment, the energy recovery appliance of the present invention includes a motor having 3600 rpm and an AC generator, or alternator, having 1800 rpm. Using an AC driver to control the speed and torque of the motor, the AC driver applies a load to the motor to work at half the normally required energy (i.e., 1800 rpm) without losing torque. The torque output by the motor is 3.04 Kg. This torque output is applied to a torque multiplier weighing 58.2 Kg. The torque multiplier multiplies the torque output generated by the motor by a factor of three. This increased torque output is fed to the alternator allowing the alternator to perform at full capacity (i.e., 1800 rpm), as illustrated below:

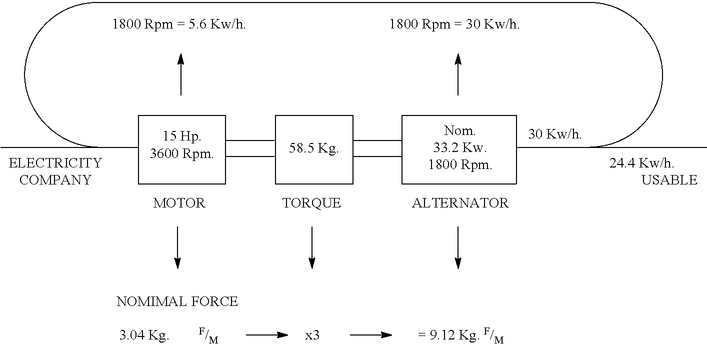

As shown by the example above, approximately 30 kWh are generated from the alternator (or AC generator) of which approximately 24.4 kWh can be used to supply the energy consumption needs of the consumer. A smaller portion (approximately 5.6 kWh) is fed back to the motor to maintain continuous power to the motor. If the energy demand is greater than the approximate 24.4 kWh generated with the use of one generator, then, multiple generators may be coupled together (e.g., in parallel) to increase the energy output.

The generator generates the necessary energy sufficient to meet all of the user's utility demands. As the user is also connected to the commercial electric energy provider, all the surplus energy generated by the present invention is returned to the commercial supplier through the bidirectional meter (and a reading is taken—for credit purposes) creating a net positive count in the user's favor (e.g., amount of energy delivered by the utility provider less the returned excess energy generated by the present invention), thereby reducing the consumer's energy consumption by as much as 99%.

In another embodiment, the consumer may send more energy back to the utility provider than what is delivered to the consumer and get paid for the excess amount “returned.” This returned energy may then be distributed by the utility company among other consumers. The consumer may request the amount of kilowatts needed and more to send back to the electricity service provider.

In an alternative embodiment, the present invention may include (as an extra accessory) an uninterruptable power supply (UPS) to provide emergency power when electricity from the utility provider fails while connected to the electric power grid of electricity provider. This application must be pre-established during installation as either a recuperation appliance or as an emergency plant.

In yet another alternative embodiment, the present invention has its application in a rural setting and may generate the amount of electricity needed independent of and without being connected to an electric power grid (“off grid”) of an electricity provider. This alternative embodiment also requires an uninterruptable power supply (UPS). Such use is ideal for a green project or for a place without an electricity provider or as a power plant.

The present invention is installed and connected, or coupled, into the electric installation of the home or business of the end user. The installation of the generator is best performed by trained personnel. To begin installation, it is necessary to mark the location where the generator will be located. Installation can be made outdoors. However, given its properties and price, and depending on the climate—extreme climates in particular—the present invention should be kept in a covered, fresh, closed area with access to the air conditioning unit of the home or business to maintain and maximize durability. The location requires an area of at least 25 cm from a wall of a building (home or business). The location should be dry, covered and even.

A base is installed to provide a platform for the generator. The generator is mounted onto and rests upon the base. The base is raised such that the generator and its housing are not exposed (at least not continuously) to moisture from the ground, e.g., rain, snow, dew, etc. The dimensions of the base should be larger than the generator. The dimensions of the base are 140 cm long by 65 cm wide by 7 cm high, approximately.

The control box, which controls performance of the generator, is mounted on the wall, preferably inside of the building (home or business) to avoid rain, dirt, moisture and tampering by unauthorized individuals or vandals. The appropriate electric lines, including the ground line, are then connected to the generator. Connections are also made between the generator and control box. A computer is connected to the generator to calibrate the generator using a predetermined program. This calibration must take place during installation of the generator at the home or business of the consumer. Once the generator has passed all of the initial testing, the generator is ready for use. The present invention is compact, efficient, does not generate contaminant emissions and is not invasive.

It is an object of the present invention to take advantage of the power transmission from the utility provider to the home or business by utilizing a portion of that transmitted energy to power an electric generator.

It is a further object of the present invention to generate sufficient power to power the home or business in a rural setting to reduce a consumer's dependency on a utility provider

It is still a further object of the present invention to “return” power generated by an electric generator in excess of what is sufficient by the end user to power the home or business to the utility provider for a credit towards the user's account (thus, lowering the user's energy consumption costs from 50% to 99%) or for a payment for the exported power generated by the consumer (depending on the amount of energy generated and exported by the consumer to the utility provider).

It is a further object of the present invention that the public generate their own electric energy in a clean, independent and responsible manner, thus contributing to the improvement of the quality of life economically and ecologically thereby creating and later increasing public energy independence and ecological conscience.

One advantage of the present invention is that the energy returned to the utility provider is clean and of high quality. Another advantage is that through the continued use of the present invention, consumers become more aware of the benefits of producing their own clean power and minimize their dependency on fossil based fuels, such as gas. Such awareness or energy consciousness leads to the consumer switching from fossil fuel powered appliances over to clean electrically powered appliances and reducing the carbon footprint being left behind which, in turn, further reduces environmental pollution.

There is a need for an electric generator that allows for a relatively short period of time for a complete return on investment, has zero emission contaminants, zero nonrenewable combustible consumption and is compact, convenient and aesthetically pleasing.

As used herein, the terms “utility provider,” “utility supplier,” “utility service provider,” “utility company,” “electricity provider,” “electricity service provider,” “electricity supplier” and “electric company” are synonymous. Similarly, “consumer,” “user,” and “end user,” are also synonymous. “Electricity,” “power,” and “electrical power” are also synonymous.

### BRIEF DESCRIPTION OF THE SEVERAL VIEWS OF THE DRAWINGS

FIG. 1 is a front perspective environmental view of an embodiment of the present invention.

FIG. 2 is a front perspective view of an embodiment of the generator of the present invention.

FIG. 3 shows a front view of the control module mounted within a panel of the control box of the present invention.

FIG. 4 depicts a rear view of the control module mounted within a panel of the control box of the present invention.

FIG. 5 shows a front view of the electronics panel of the present invention.

FIG. 6 shows a front perspective view of an alternative embodiment of the present invention.

FIG. 7 depicts an embodiment of the co-generation system of the present invention.

FIG. 8 depicts an alternative embodiment of the co-generation system of the present invention.

FIG. 9 depicts an alternative embodiment of the co-generation system of the present invention.

FIG. 10 depicts an alternative embodiment of the co-generation system of the present invention.

FIG. 11 is a graphical representation of the return on investment over time of the present invention.

### DETAILED DESCRIPTION OF THE INVENTION

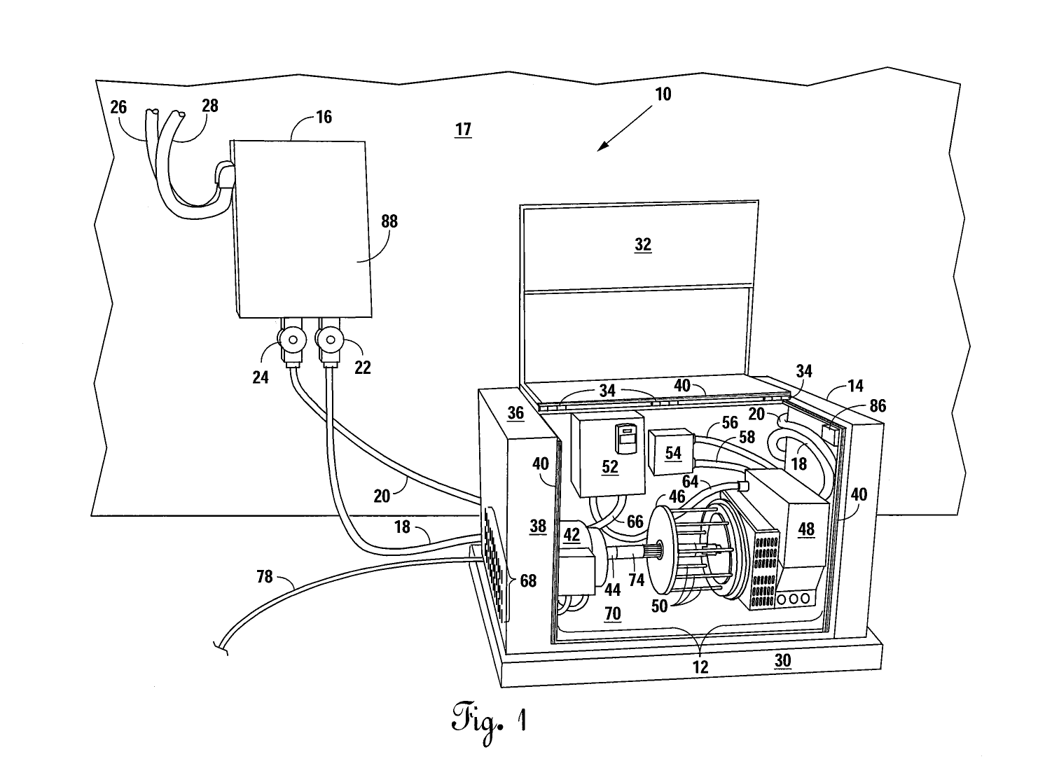

FIG. 1 depicts an embodiment of the present invention. Renewable energy assembly 10 is comprised of generator 12 and control box 16. Generator 12 is enclosed within housing 14. Control box 16 is mounted on wall 17 and is in electronic connection with generator 12 enclosed in housing 14.

Cover 32 is attached to top 36 of housing 14 using hinges 34, although other types of similar attachments may also be used. To open, cover 32 is swung about an axis parallel to hinges 34 to rest on top 36 of housing 14. In the open position, generator 12 and its components are exposed for easy access thereto by a user. To close, cover 32 is rotated about an axis parallel to hinges 34 toward front 38 of housing 14 thereby sealing generator 12 wholly within housing 14. Vents 68 on exterior of housing 14 allow any excess heat generated or any hot humid air build up within housing 14 to be vented out. Housing 14, thus, provides external protection to the components within from the natural elements, including the sun, wind, dust and rain. Weather stripping 40 between where cover 32 and housing 14 come together provide additional protection against moisture or precipitation (e.g., rain, snow, etc.) or dust.

In one embodiment, the dimensions of generator 12 with housing 14 are approximately 140 cm×70 cm×70 cm. Housing 14, containing generator 12 therein, rests on an installation base or platform 30 which is slightly larger than housing 14. In one embodiment, platform 30 is approximately 130 cm long by 110 cm wide by 7 cm high. In another embodiment, platform 30 may be approximately 140 cm long by 65 cm wide by 7 cm high. One of the functions of the platform is to protect the generator in the event of flooding. Otherwise, the size of the platform is not critical so long as the generator fits within the boundaries of the platform. It is contemplated that variances of these dimensions can be made and still be within the scope of the invention.

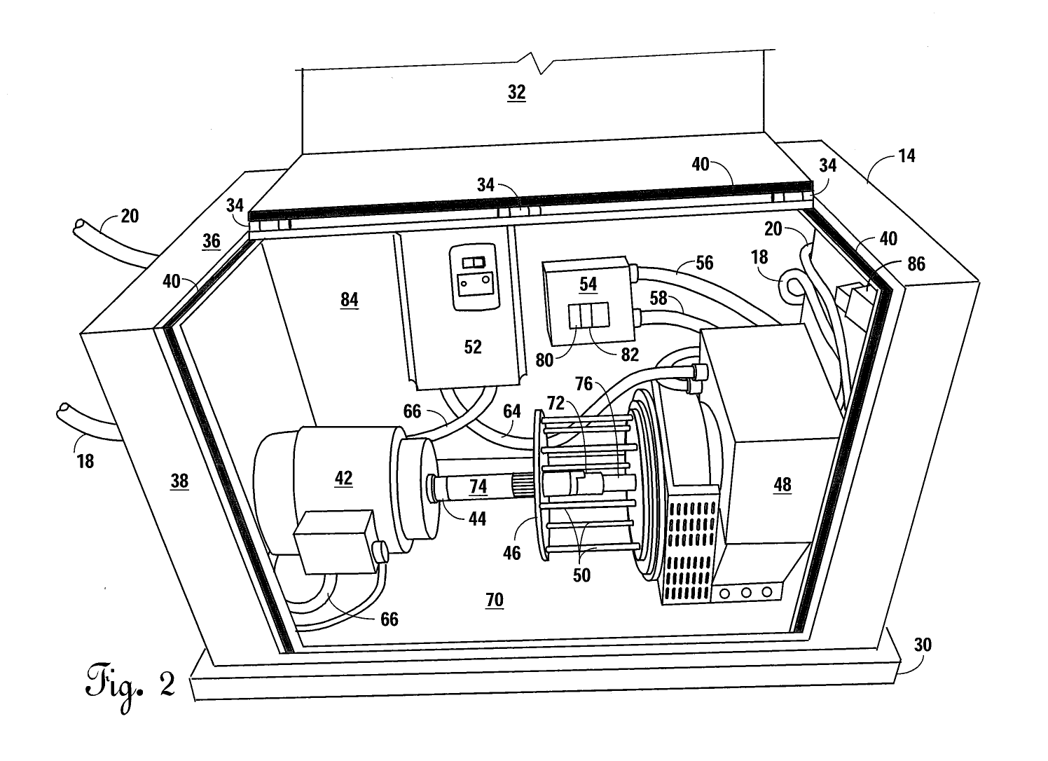

Referring now to FIG. 2, AC driver (speed control) 52 works with alternating current (AC current). AC driver 52 is electrically connected to and provides AC current to motor 42 via conduit 66. In the present invention, motor 52 is a 15 hp 3600 rpm WEG Motor model 01536ET3M254TW. AC driver 52 feeds motor 42 with half the normally required energy without reducing torque output by motor 42. Motor 42 converts electrical energy received from AC driver 52 into rotational mechanical energy sufficient to turn output shaft 44. In the present invention the AC driver is an N3, A510 AC Driver by Teco Westinghouse.

Counterweight torque multiplier 46 has a disc configuration and is connected at one end to output shaft 44 via coupler 74. Alternator 48 mechanically connects to counterweight torque multiplier 46 via input shaft 76. Coupler 72 connects output shaft 44 to input shaft 76 of alternator 48. A plurality of bars 50 is attached to torque multiplier 46 on one end and to alternator 48 on the other end, thereby providing additional structural stability. Torque multiplication takes place when torque multiplier 46 augments the torque output of motor 42 by a factor of three and sends this increased power to alternator 49 via coupler 74. Automatic voltage regulator (AVR) 86, shown mounted outside alternator 48, is electronically connected to alternator 48 and maintains a constant quality and voltage level in the AC current generated by alternator 48. In the present invention, alternator 48 is a 33 Kwh, 1800 rpm, 4 pole, double bearing, 60 Hz (depending on Hz needs) alternator with external control support AVR. Motor 42 is a 15 hp, 3600 rpm, 60 Hz (depending on Hz needs), 2 pole motor. However, the alternator and motor models can be changed as long as they comply with the specific requirements of the present invention and would still be within the contemplated invention.

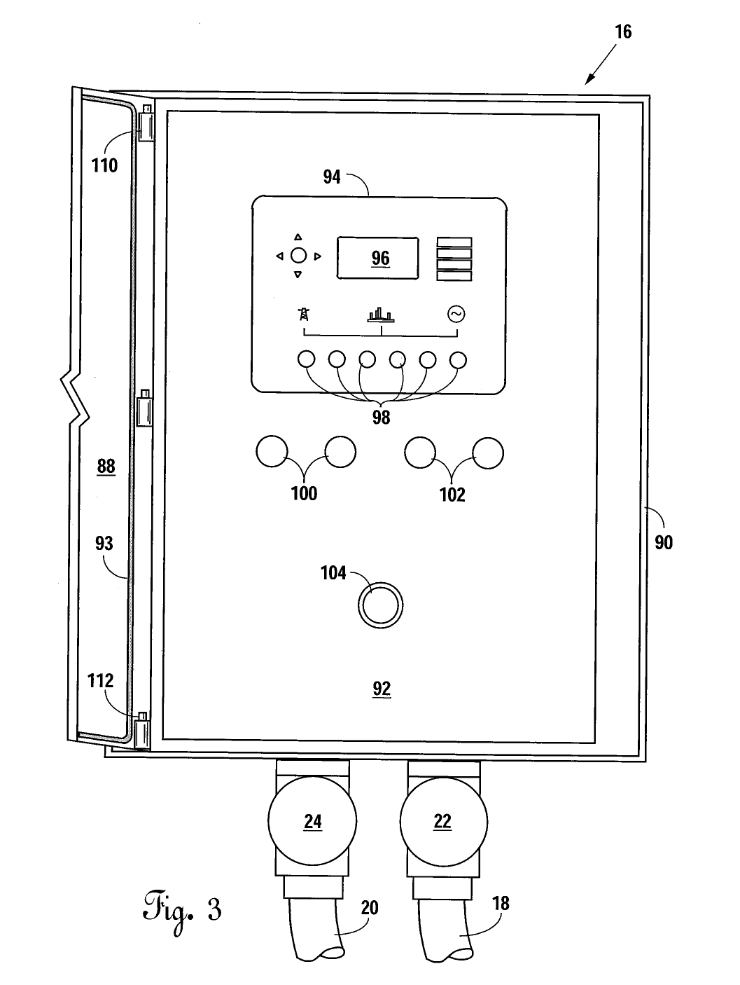

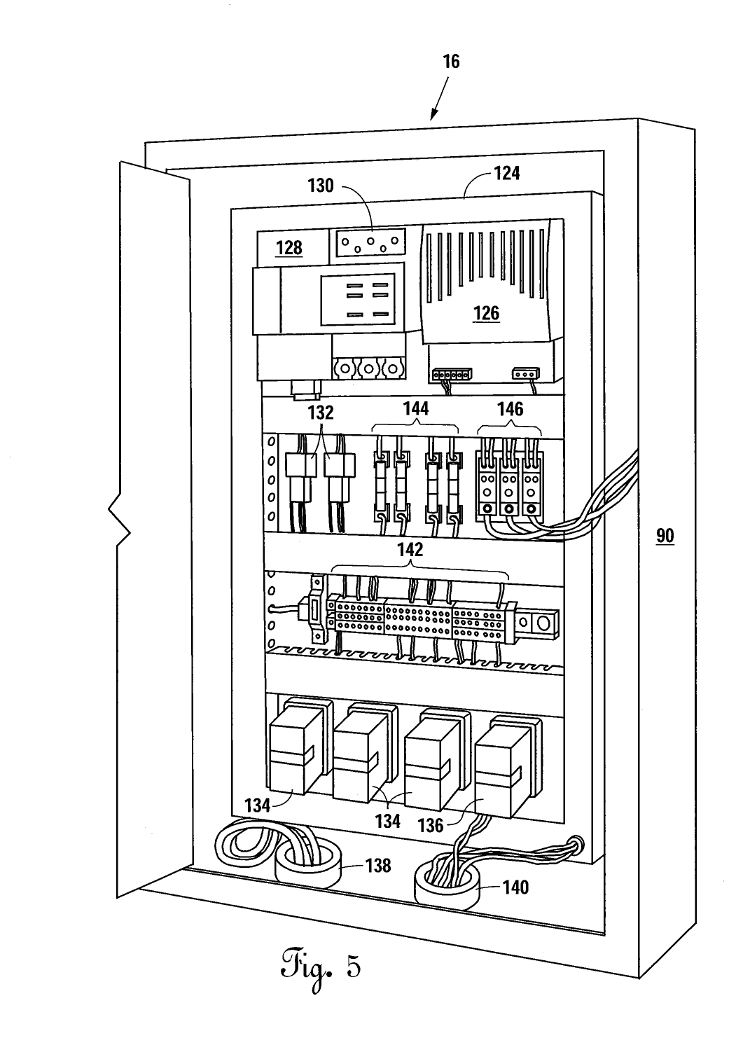

Generator 12 is electrically connected to control box 16 via conduit lines 18 and 20. Clamps 22 and 24 secure conduit lines 18 and 20 to control box 16. Conduit line 18 receives power from clamp 140 (see FIGS. 3 and 5). Conduit line 20 sends power to clamp 138 (see FIGS. 3 and 5).

Still referring to FIG. 2, circuit breaker load center 54 having switches 80 and 82 are electrically connected to AC driver 52 and alternator 48 via conduits 56 and 58. Circuit breaker load center 54 receives power from the electricity supplier and from alternator 48 via conduit 56. Circuit breaker load center 54 then sends out power received towards AC driver 52 and control box 16 via conduit 58, creating the surplus energy and sending it out towards the electricity supplier. Circuit Breaker Load Center 54 has two (2) switches (switches 80 and 82). One switch receives energy from the electricity supplier. The other switch receives energy from alternator 48. The switch that receives energy from the electricity supplier goes to AC driver 52. The switch receiving energy from alternator 48 goes to control box 16. Motor 42 and alternator 48 are mounted on to base 70 within housing 14. For convenience, easier access, and providing as much free space as possible within housing 14, AC driver 52 and circuit breaker load center 54 may be mounted to inside rear panel 84 of housing 14, but should be mounted inside control box 16.

To install the present invention, an installation base or platform 30 is placed in a dry, covered and even area adjacent to the location (e.g., building) where generator 12 will be used. The area should be at least 25 cm from an outside wall of the building. Housing 14 rests on platform 30 which is slightly larger than housing 14. Platform 30 is sufficiently high enough to keep generator 12 and housing 14 from contacting wet soil, as, for example, when it rains or snows. In the present invention, the base is 140 cm long by 65 cm wide by 7 cm high, though these dimensions can vary depending on the size of the generator being used (urban or rural). Other sizes are contemplated and do not exceed the invention as contemplated herein.

The present invention may be utilized by the consumer. However, for safety reasons, the consumer only has limited access for certain limited purposes, such as pressing the emergency stop button and manually turning the unit on or off on/off application this for the users safety. In all other instances of use, trained personnel are required, e.g., installation, calibration, and maintenance of the present invention. The service life utility of the present invention is approximately 20 years, provided routine maintenance on a regularly scheduled basis is performed by trained and authorized personnel.

Referring now to FIG. 3, control box 16 has a front panel 88 that opens about an axis parallel to pivot hinge 110 and pivot hinge 112. In the present invention, front panel 88 is made of a dark semi-transparent, lightweight material, such as Plexiglas, polycarbonate or other similar material. Opening front panel 88 exposes middle panel 92 containing control module 94. Weather stripping 93 along perimeter of inside edge of front panel 88 provides protection against dust and moisture. Control module 94 contains display 96 providing the user with the status of control module 94. Control module 94 further contains a plurality of controls 98 and warning lights 100 and 102. Emergency stop button 104 immediately shuts down the system when necessary.

Still referring to FIG. 3, in the present invention, control box 16 is a Deep Sea Electronics (DSE) programmable logic controller (PLC), Control Module, Model 8620. In one embodiment, control box housing 90 is made up of material that has a National Electrical Manufacturers Association (NEMA) rating of 3. The dimensions of the control box are approximately 80 cm×60 cm×30 cm. It is contemplated that variances of these dimensions can be made and still be within the scope of the invention.

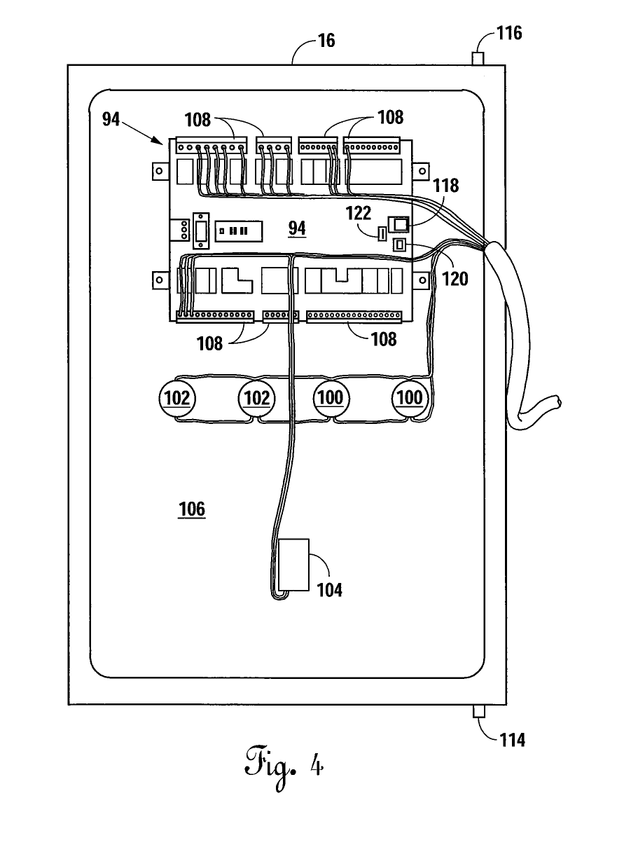

Referring now to FIG. 4, middle panel 92 opens by rotating about an axis parallel to pivot hinge 114 and pivot hinge 116 exposing back 106 of middle panel 92. A plurality of terminals 108 on the back side of control module 94 provides the necessary wire connections for control module 94. Connections to local area networks (LAN) are accomplished via Ethernet jack 118 for either on-site or remote control of control module 94, and thus, the renewable energy assembly 10, by the programming or maintenance specialized crew or trained personnel. Control module 94 may also be connected to a computer, laptop, tablet or other similar device, via PC jack 120, the USB 122 is used to download activity records by the maintenance specialized crew or trained personnel.

FIG. 5 shows electronics panel 124 contained within control box housing 90. Wires within conduit 20 traverse in and connect to control box housing 90 via clamp 138. Wires within conduit 18 traverse in and connect to control box housing 90 via clamp 140. A plurality of current transformers 134 and a plurality of current transformers 136 step up or step down the current voltage as appropriate Current transformers 134 come from alternator 48. Current transformer 136 comes from the electricity provider's line 1. Current transformers 134 are 100/5 A. Current transformer 136 is 150/5 A. Battery 126 is a power source (replacing the use of a 24V DC battery) and is mounted on electronics panel 124. The power source of the present invention is a Deep Sea Electronics, 24V self-seeking power supply, Model No. DSE 160.

Still referring to FIG. 5, motorized operating mechanism 128 may also be mounted on electronics panel 124 and is positioned adjacent to and actuates molded case circuit breaker 130 in the event of power failure. In the present invention, motorized operating mechanism 128 is a Siemens Motorized Operating Mechanism, Model No. 3VT9100. Molded case circuit breaker 130 is a Siemens Molded case circuit breaker, Model No. 3VT1. Relays 132 connect to control module 94 and receive signals from control module 94 in 24V to close or open motorized operating mechanism 128 and relay signals therebetween. A plurality of terminals 142 connects to control module 94. A plurality of fuses 144 connects energies from alternator 48 to control module 94 and from the electricity supply to control module 94. A plurality of clamps 146 connects the electricity supply to control box 16.

Control box 16 interfaces with a Windows-based computer via PC jack 120 (see FIG. 4). Control module 94 is the “brain” that starts and stops generator 12 depending on the amount of hours generator 12 is set to work (which is determined and set, i.e., programmed, by a specialized and trained programmer). Control box 16 further monitors that all component parts are safe and working correctly. Control box 16 further checks that the electricity levels are correct for the coupling. The control box is programmed by trained personnel. Programming of the control box 16 may be done at the control box or from some remote location. The present invention may be controlled or monitored remotely from a computer, cell phone or personal tablet device, such as an iPad or other similar device.

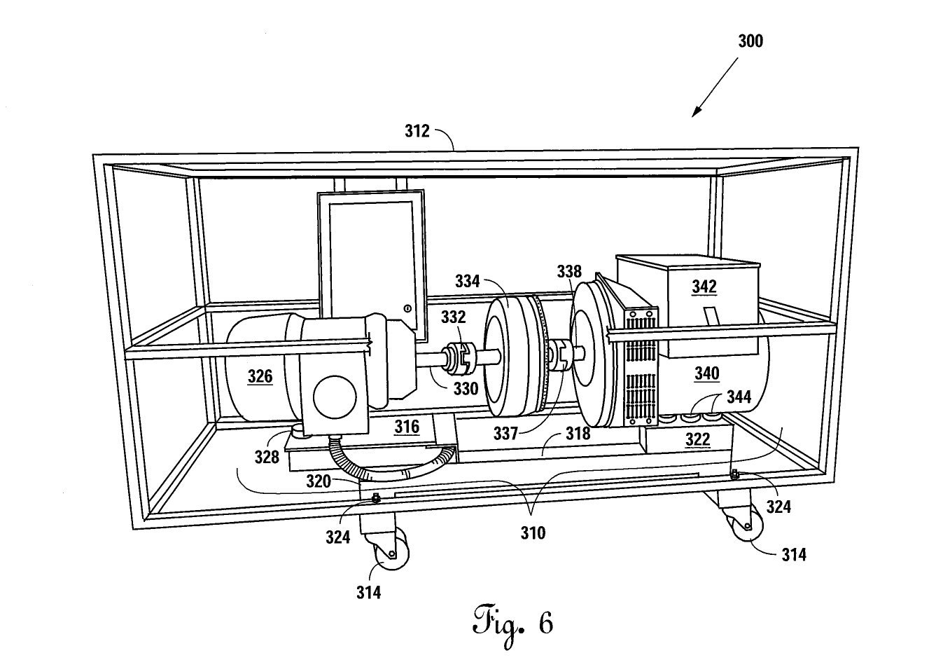

Referring now to FIG. 6, alternative embodiment 300 of the generator portion (without housing) of a renewable energy assembly is shown. Alternative embodiment 300 is comprised of generator 310 contained within frame 312. Panels (not shown) making a housing (not shown) are integrated into frame 312 forming a volume therein. Generator 310 is comprised of motor 326, torque multiplier 334 and alternator 340, all connected in series and rotatably fixed to a shaft using couplers 332 and 337.

Output shaft 330 extends distally from motor 326 and mechanically connects motor 326 to torque multiplier 334 via coupler 332. Input shaft 338 mechanically connects torque multiplier 334 to alternator 340. Automatic voltage regulator (AVR) 342 is electronically connected to alternator 340 and maintains a constant quality and voltage level in the AC current generated by alternator 340.

Still referring to FIG. 6, both motor 326 and alternator 340 are mounted on structures within frame 312. Motor 326 is mounted on mounting plate 316. Rubber mounts 328 are attached between mounting plate 316 and motor 326 and act as buffers to reduce noise levels and vibration when generator 310 is in use. Alternator 340 is mounted to end 322 of mounting frame 318. Rubber mounts 344 are attached between alternator 340 and end 322 of mounting frame 318 and act as buffers to reduce noise levels and vibration when generator 310 is in use. Mounting plate 316 is mounted on end 320 of mounting frame 318. Rollers 314 are fastened to frame 312 using fasteners 324. In the present invention, the fasteners are wing nuts fastened to bolts extending from the top of rollers 314. However, other types of fasteners, such as nuts or the like, may be used.

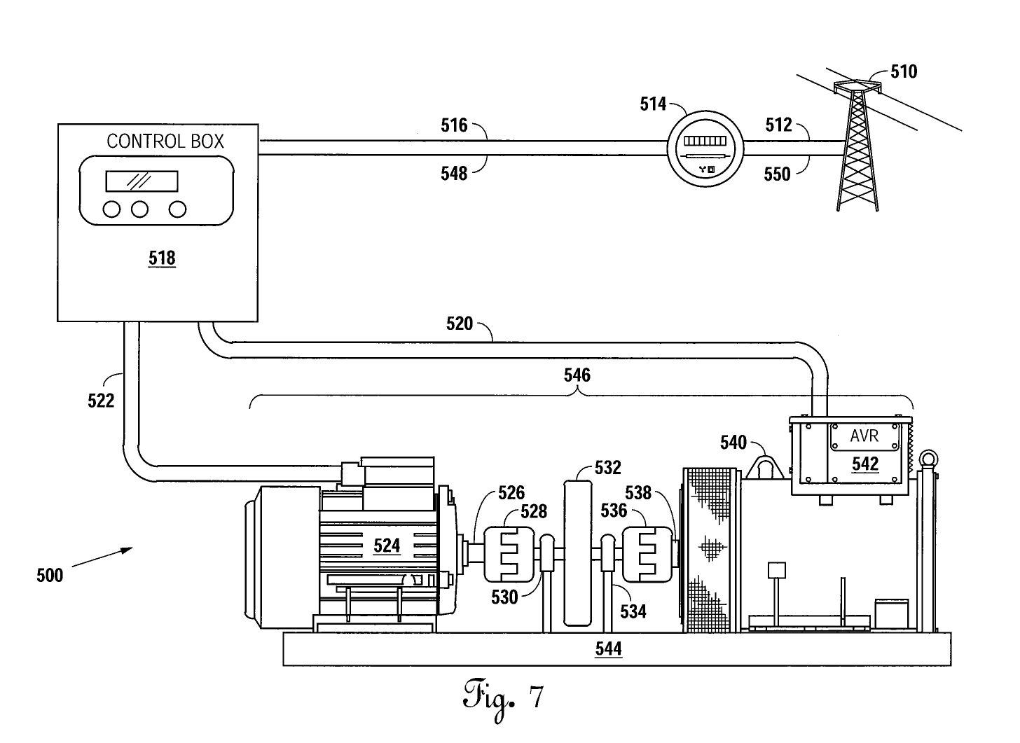

In an alternative embodiment, renewable energy assembly 10 may be incorporated into a cogeneration system 500, as shown in FIG. 7. Electric power grid 510 provides power through incoming power line 512 to bidirectional meter 514 where a measurement of the incoming power is taken. Power, or electricity, then continues through cable 516 to control box 518. Electricity then passes through conduit 522 via wires carried therein to motor 524 of generator 546. The electrical current is converted into mechanical rotational energy by motor 524 and transferred along output shaft 26 through torque multiplier 532 which increases the torque output produced by motor 524 by a factor of three. The increased torque output is transferred through input shaft 538 to alternator 540.

Output shaft 526 of motor 524 is connected to torque multiplier 532 via coupler 528. Input shaft 538 of alternator 540 is connected to torque multiplier 532 via coupler 536. Output shaft 526 and input shaft 538 are supported by support 530 and support 534, both positioned on opposite sides of torque multiplier 532, as shown in FIG. 7.

Automatic voltage regulator (AVR) 542 is electronically connected to alternator 540 and maintains a constant quality and voltage level in the AC current generated by alternator 540. Electricity generated by alternator 540 is then transferred to control box 518 via conduit 520 via wires carried therein. A portion of the electricity generated by generator 546 is then distributed to the home or business to meet the electricity demands of the consumer. Additionally, a portion of the electricity generated by generator 546 is directed to continue powering generator 546 via control box 518. The excess power generated by generator 546 is then “returned” to the utility provider via cable 548 where the returned excess power first passes again through bidirectional meter 514 (where measurement of the outgoing power is taken) before the excess power is exported to and incorporated into electric power grid 510 for distribution to other customers.

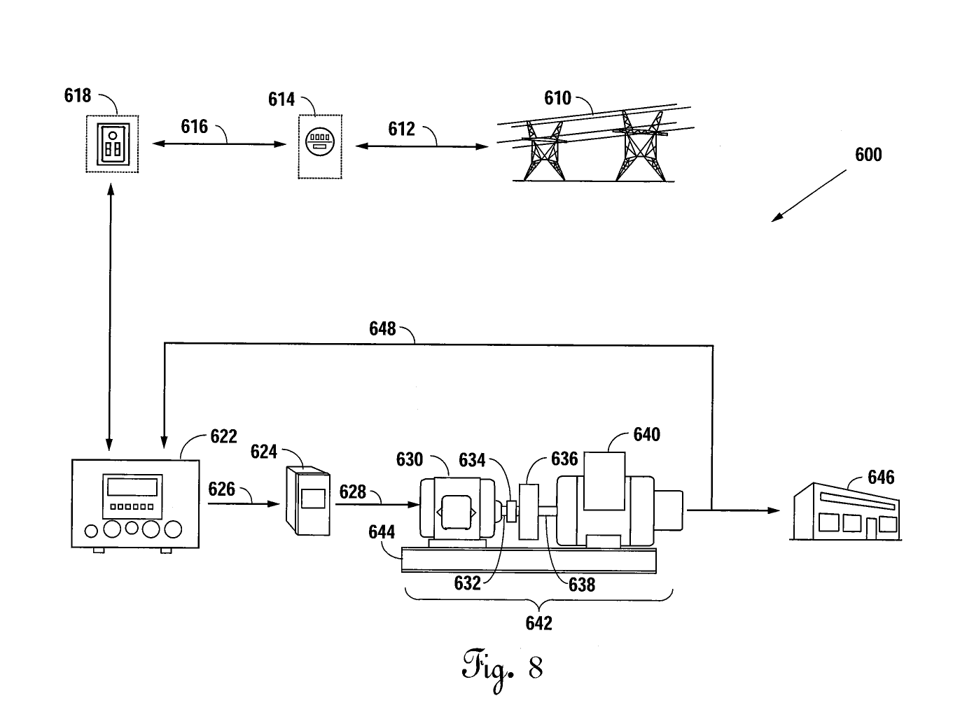

FIG. 8 shows alternative embodiment cogeneration system 600. A cogeneration system, as described herein, exists when energy generated by a utility provider and energy generated from a consumer using an electric generator are coupled together to provide sufficient power to meet electrical demands of the consumer and any power generated in excess of what is necessary to power the home or business of the consumer is returned to the utility provider. As shown in FIG. 8, electric power grid 610 transfers power generated by a utility service provider to bidirectional meter 614 of a user via bidirectional power line 612. The power enters the main power switch 618 through bidirectional cable 616. Power is then transferred via bidirectional cable 620 to control box 622. Electricity is then sent to AC driver 624 via wire 626. AC driver 624 turns on and controls the speed of motor 630 with the energy received from control box 622 which is then used to power motor 630 of generator 642 which rests on base 644.

Motor 630 converts the electrical energy into mechanical rotational energy which is then translated through output shaft 632 to torque multiplier 636 via coupler 634. Torque multiplier increases the torque input threefold from the torque output generated by motor 630. Energy is then translated to alternator 640 via input shaft 638. Electricity generated by generator 642 is then directed to the home or business 646. Excess energy is fed back through feedback loop 648 to control box 622 to repeat the energy generating process and continue powering generator 642. Additional energy produced above and beyond what is required by the user is returned to main power switch 618 via bidirectional cable 620. The excess power enters bidirectional meter 614 via bidirectional cable 616 where a measurement of the outgoing power is taken before the outgoing power is incorporated into power grid 610.

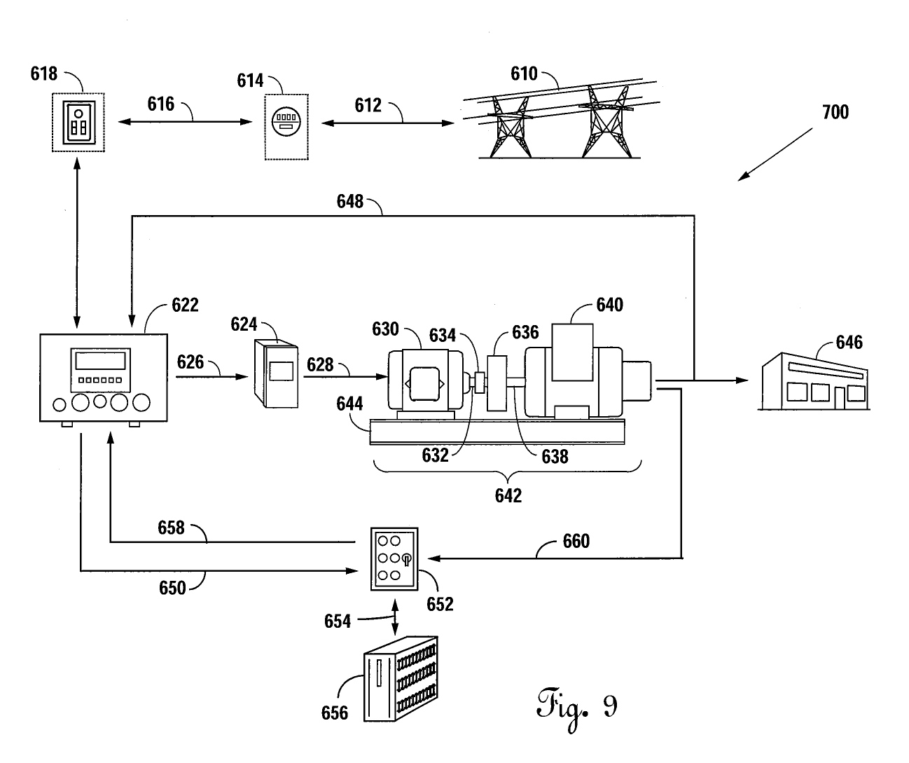

FIG. 9 shows an alternative embodiment 700 of the present invention. With one exception, described below, the majority of components are identical to and function the same as those described with respect to cogeneration system 600, as shown in FIG. 8. The same reference numbers are used for those components for convenience. The added component is an uninterruptible power supply (UPS) and its respective UPS control box which together provide an additional path in which the power generated by generator 642 may take. The UPS of the present invention is an online/double-conversion UPS from Industronic, Model UPS-IND 1346, though other similar devices are contemplated and may be used and still be within the invention as contemplated herein.

During normal use, some power is transferred from control box 622 to UPS control box 652 and routed to UPS 656 which continuously charges a battery (not shown) therein. In the event there is an interruption of the power being transferred from electric power grid 610 (which would shut down the cogeneration system), UPS 656 receives a signal from UPS control box 652 automatically causing UPS 656 to supply sufficient energy to control box 622 via UPS control box 652 to maintain power to generator 642. At this point, output energy from generator 642 is diverted into 3 distinct paths: the first is to provide sufficient energy to satisfy the energy demands of a home or business; the second is to provide energy via feedback loop 648 to control box 622 to continue powering generator 642 via AC driver 624; the third is to provide power back to UPS control box 652 which is then transferred to and powers a battery (not shown) within UPS 656. This process continues until such time as power is restored from electric power grid 610.

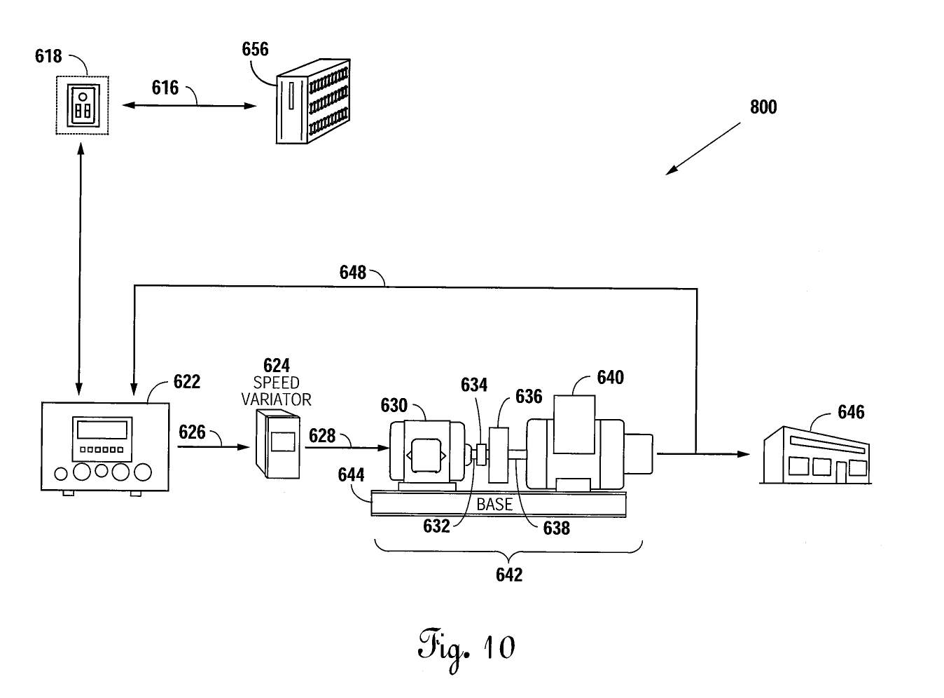

FIG. 10 depicts an alternative embodiment 800 of the present invention. As the majority of components are identical to and function the same as those described with respect to cogeneration system 600, as shown in FIG. 8, the same reference numbers are used for those components for convenience. In this embodiment, there is no cogeneration system. Instead, the system functions independently of any electric power grid. Generator 642 is powered through the use of UPS 656 which replaces power from an electric power grid. Energy from UPS 656 is routed to the main switch box 618 via bidirectional cable 616. Electricity is then transferred to control box 622 via bidirectional cable 620. Energy generated from generator 642 is directed to home or business 646 sufficient to meet the power demands of the user. A portion of the energy generated by generator 642 is fed back via feedback loop 648 to control box 622 to continue powering generator 642 via AC driver 624. This embodiment has its application in a rural setting where there is no electric power grid and the present invention functions as an independent power generation plant. In this embodiment, the amount of energy produced to be consumed is less than the amount of energy produced to cogenerate. Where the generator will be required to work continuously for 24 hrs, this will diminish its life span. In this scenario, three (3) generator systems may be coupled together (in parallel) to provide the necessary energy to be consumed.

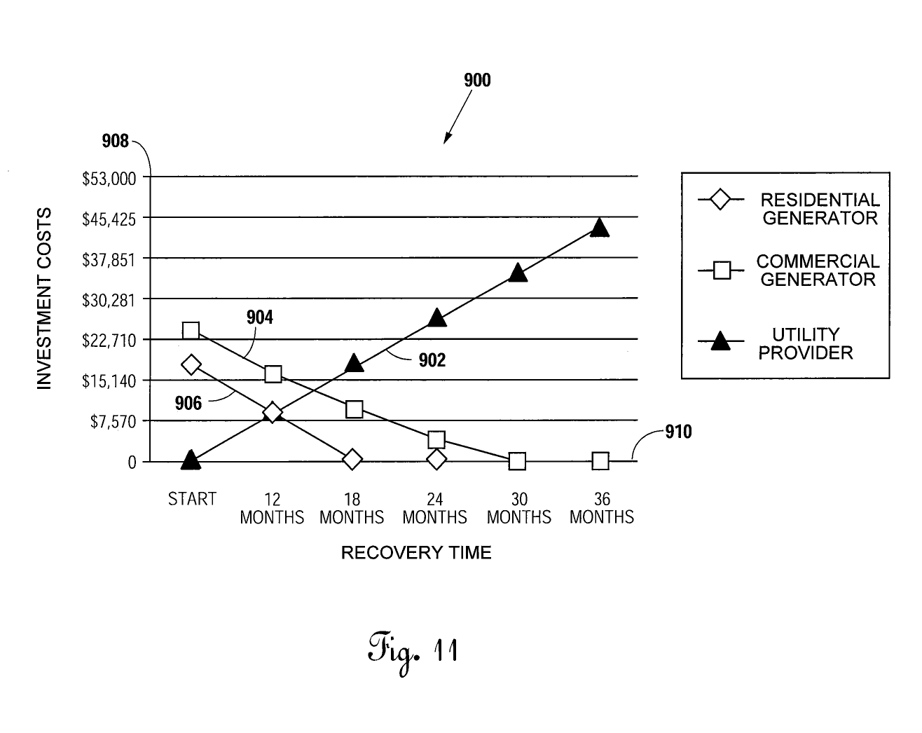

FIG. 11 is a graphical representation (graph) 900 of the return on investment by the consumer over time using the present invention. The x-axis 910 represents the recovery time (in months) the consumer needs in order to recoup his or her investment. The y-axis 908 represents the investment cost (in dollars) to the consumer.

Investment cost points of graph 900 correspond to expenditures (money paid) by the consumer at any given month. Recovery time points correspond to the amount of time passed during which a consumer sees a reduction in expenditures as compared to earlier months. For example, for an urban commercial setting 904, for an initial investment of about $22,710, the consumer would see a reduction in cost of about $7,570 within about 12 months. An additional reduction cost of about $7570 (or totaling a cumulative reduction in cost of about $15,140) would be seen in about 18 months.

Similarly, for urban residential setting 906, with an initial investment cost of just over $15,140 the consumer would see a reduction of approximately half (or $7570) after about 12 months. In another about 6 months, the consumer would recoup their initial investment. Conversely, with no initial investment (zero dollars) using solely utility provider 902 and without the present invention, a consumer's energy consumption costs by the utility provider are approximately $7570 in the first year. Expenditures reach over $15,000 within about 18 months of initiating service and will continue to rise thereafter.

This graph 900 demonstrates the reduction in payments (and financial savings) by the consumer over time until such time as the cost for power to the consumer becomes nominal. With the application of the present invention, the use of an embodiment of the present invention in an urban residential setting 906 allows the consumer to recoup his or her investment in as little as 18 months. The total recoupment time for an urban commercial setting 904 is approximately 30 months. The result of the implementation of the present invention, as shown in FIG. 11, confirms that without the present invention, a consumer continually pays utility provider 902 for the delivery of power to the consumer at an increasing amount over time.

The various embodiments described herein may be used singularly or in conjunction with other similar devices. The present disclosure includes preferred or illustrative embodiments of specifically described apparatuses, assemblies, and systems. Alternative embodiments of such apparatuses, assemblies, and systems can be used in carrying out the invention as claimed and such alternative embodiments are limited only by the claims themselves. Other aspects and advantages of the present invention may be obtained from a study of this disclosure and the drawings, along with the appended claims.

We claim:

1. A system for generating and recovering energy, said system comprising:
an electric network;
a bidirectional meter connected to said electric network for receiving electrical power transmitted therefrom wherein said bidirectional meter measures power delivered by said electric network;
a main power switch electrically connected to said bidirectional meter, said main power switch receiving said electric power being transmitted through said bidirectional meter;
a control box electrically connected to said electric network;
an electric generator electrically connected to said control box, said electric generator comprising:
an AC driver electrically connected to said control box;
a motor having a shaft extending distally therefrom, said motor electrically connected to said AC driver for receiving power therefrom and generating a first torque output;
a torque multiplier mechanically connected to said motor wherein said torque multiplier multiplies said first torque output from said motor to produce a second torque output;
at least one coupler rotatably mounted on said shaft between said torque multiplier and said motor;
an alternator mechanically connected to said torque multiplier, said alternator receiving second torque output from said torque multiplier to generate power and transmitting power generated to a remote location; and
a base having said electric generator mounted thereon.

2. The system for generating and recovering energy, as recited in claim 1, further comprises a housing encasing said generator, said housing mounted on said base.

3. The system for generating and recovering energy, as recited in claim 1, wherein said second torque output is greater than said first torque output by approximately a factor of three.

4. The system for generating and recovering energy, as recited in claim 1, wherein said AC driver controls the speed of said motor;

5. The system for generating and recovering energy, as recited in claim 1, wherein said alternator is electrically connected to said control box, said alternator transmitting a portion of said power generated to said control box.

6. The system for generating and recovering energy, as recited in claim 5, wherein said remote location is a location requiring energy consumption.

7. The system for generating and recovering energy, as recited in claim 6, wherein a portion of said energy received by said control box from said alternator is exported to said electric network, said exported energy being in excess of the energy consumption demands of said remote location.

8. The system for generating and recovering energy, as recited in claim 7, wherein a credit or payment is provided in exchange for said exported energy.

9. The system for generating and recovering energy, as recited in claim 1, further comprising a computer connected to said control box for calibrating, testing, and controlling said control box on site or by remote access, said calibrating, testing, and controlling performed using a predetermined computer program.

10. The system for generating and recovering energy, as recited in claim 1, further comprising:
an uninterruptible power supply electrically connected to said control box; and
an uninterruptible power supply control box in electrical connection therebetween, said uninterruptible power supply control box receiving a signal from said control box when power failure occurs and transmitting said signal to uninterruptible power supply to initiate power supply to said control box.

11. A system for generating energy, said system comprising:
an uninterruptible power supply;
a main power switch electrically connected to said uninterruptible power supply for receiving power therefrom;
a control box electrically connected to said uninterruptible power supply;
an electric generator electrically connected to said control box, said electric generator comprising:
an AC driver electrically connected to said control box;
a motor having a shaft extending distally therefrom, said motor electrically connected to said AC driver for receiving power therefrom and generating a first torque output;
a torque multiplier mechanically connected to said motor wherein said torque multiplier multiplies said first torque output from said motor to produce a second torque output;
at least one coupler rotatably mounted on said shaft between said torque multiplier and said motor;
an alternator mechanically connected to said torque multiplier, said alternator receiving second torque output from said torque multiplier to generate power and transmitting power generated to a remote location; and
a base having said electric generator mounted thereon.

12. The system for generating energy, as recited in claim 11, wherein a portion of said energy generated by said alternator is transmitted to a remote location;

13. The system for generating energy, as recited in claim 12, wherein a portion of said energy generated by said alternator is transmitted to said control box to continue powering said AC driver;

14. The system for generating energy, as recited in claim 13, wherein a portion of said energy received by said control box from said alternator is transmitted to said uninterruptible power supply to recharge a power source therein.

15. The system for generating energy, as recited in claim 12, wherein said remote location is a location requiring energy consumption;

16. The system for generating energy, as recited in claim 15, wherein two or more of said electric generators may be coupled to increase output power.

17. A method of installation of a renewable energy system, said method comprising the steps of:
locating an area at least 25 cm from a wall of a building;
placing a base at least 25 cm from said wall, wherein said base is 140 cm long by 65 cm wide by 7 cm high;
first mounting a generator on said base;
second mounting of a control box on said wall;
identifying at least one electrical line, wherein said at least one electric line includes a ground line;
first connecting said ground line to said generator;
second connecting interconnection cables of said control box to said generator;
third connecting said generator to a computer;
calibrating a predetermined program with said computer; and
testing said generator against said predetermined program.

18. The method of installation, as recited in claim 17 wherein said generator comprises:
a base;
a motor mounted on said base;
an alternator mounted on said base;
a torque multiplier rotatably mounted on a shaft, said torque multiplier mechanically connected to said motor and said alternator;
an AC driver in electrical connection with said motor and said alternator; and
a housing enclosing said motor, said alternator, said torque multiplier, and said AC driver, said housing mounted on said base and having a cover for access therein.
